(19) United States
(12) Patent Application Publication
(10) Pub. No.: US 2007/0130618 A1
(43) Pub. Date: Jun. 7, 2007

(54) Human-factors authentication

(76) Inventor: Chuan Pei Chen, Auckland (NZ)

Correspondence Address: YOUNG & THOMPSON, 745 SOUTH 23RD STREET, 2ND FLOOR, ARLINGTON, VA, 22202, US

(21) Appl. No.: 11/527,523

(22) Filed: Sep. 27, 2006

(30) Foreign Application Priority Data
Sep. 28, 2005 (NZ) 541711

(51) Int. Cl. H04L 9/32

(52) U.S. Cl. 726/8

(57) ABSTRACT

A method of enhancing online security by requiring the user to choose from among multiple objects presented to the user an object which falls within an abstract object definition previously provided by the user. The presented objects are therefore unknown to the user but include at least one with a particular quality known to the user.

### TECHNICAL FIELD

The invention generally relates to the online authentication System through continuous human interactivities.

More particularly, the invention relates to an authentication system which relies on information stored in a user profile and presented to a user in such a way that only the user with that profile will be able to provide a correct answer.

### BACKGROUND ART

In general, when a user is subscribed to an electronic service, a unique user identification is created along with an allocated or user selected password (or pass code) that is known to the user only. The user is verified by a connection to the service provider and the service is provided based upon the validation of the user identity.

There are several methods that are used for user authentication:
Basic authentication
Certification based authentication
Two factor authentication

Basic authentication requires the user to provide a user name/login and password to obtain services. It includes plain text (form based), encoded and various encrypted formats to protect the secrecy of the password.

Client-certificate authentication is a more secure method of authentication than basic authentication. The server and, optionally, the client authenticate each other with Public Key Certificates. Further more, the data packets may communicate over a Secure Sockets Layer (SSL) connection, to provide data encryption.

Two Factors authentication requires a user to provide two forms of identification by different methods, which is more secure again. In recent times, smart cards, biometric tokens and SMS to users' cellular phone have been used as the additional method. Smart card technology, and various biometric identification methods form, in the end, a large and complex static code; In the case of SMS, assuming that the SMS delivery network is secure, the delivery of SMS messages is not guaranteed to be timely.

Unfortunately, the nature of attacks has changed and threats from highly technical nature such Man-In-the-Middle and Trojan horses are more active.

In an example of Man-in-the-Middle attack, in which a semblance of a bank web page is presented to a diverted user, the attacker can pass a varying part of the password to the bank along with the fixed part. As with a Trojan attack, the attacker is relying on the user to log in. No amount of encryption or complex token or biometry will do any good, because all above methods have assumed that the user terminal used to obtain the service is secure.

The above authentication methods are thus either weak by nature in protection against password sniffing, or against identity theft. Mostly, the above authentication methods have relied on one, static form of identification and one method (connection based) of authentication with the exception of two-factor authentication with SMS that an authentication is carried out in two communication channels. Further, none of above methods has built in mechanism to prevent a transaction under duress.

As is the nature of human behavior a computer user tends to choose passwords that are easy to remember and this has become the weakest link in maintaining computing and information security. However, humans are also highly intelligent, unpredictable and at the same time, consistent in their actions in a way that no simple computer program can emulate.

Various methods have been provided which utilize some human characteristic to provide a login system which provides better security. Among these are GB patent specification GB2313460 which proposes to present sets of multiple images to the user so that the user can click a known sequence of images. The images are not related to the users knowledge and hence provide little improvement over a text password as far as user memorization is concerned. Also relevant is Japanese patent application 2004013865 which refers to images which are chosen at random from a database and presented to the user, the images being those which have been related, by the user, to an earlier randomly chosen image. Again there is no relationship between the users knowledge and the login data. US patent application 20030093699 refers to a series of graphical images as being required to be for access (instead of a password). The application implies nothing special about the images, and in particular, nothing to imply that they have some relationship with any special knowledge of the user. US patent application 2004030934 relates to presenting multiple images to the user so that the user can click or otherwise indicate the relevant one but the images are those which the user has been trained to recognise and there is no reference to any user knowledge in the choice of the images. US patent application 2004230843 requires the choice of images by a user from among multiple images and while this application does require images which potentially mean something to the user, the link between the user and the image is not one which is known to the presenting system, which merely presents images which have been requested. US patent application 2004250138 relates to a graphical password series in which the user invents a story around a series of passpictures. Again the images used do not relate to some hidden quality apparent only to the user, but rather to a series of qualities embedded in a story to be remembered.

Therefore, in view of the foregoing, it will be advantageous to provide a method, system and program to enhance the communication and data security, strengthen the integrity and to protect the identity of individuals in the open and harsh communication environment of the internet.

### SUMMARY OF THE INVENTION

The present invention relates to a method of authenticating a request from a user connecting to an authentication service comprising:
storing user information in the form of an abstract definition of a viewable or audible object,
receiving a request to provide authentication objects for that user,
presenting authentication objects to the requester including at least one object falling within the abstract definition,
receiving a verification request identifying the user and one of the presented authentication objects,
verifying whether the authentication object identified is one of those objects presented falling within the abstract definition,
confirming the request as authenticated where the object is correctly verified.

Preferably the authentication objects are presented to the user simultaneously.

Preferably the authentication objects are presented to the user sequentially.

Preferably there is additionally presented to a user an object representing a public code, and the user is required to enter specific parts of the public code, the parts being identified from further user information stored with the authentication service.

Preferably the authentication objects are presented by one communication means and the public code by another.

Preferably the authentication objects are presented via an internet connection and the public code via an SMS connection.

Preferably the authentication objects are presented via one communication means and the public code via a different text capable device.

Preferably the authentication objects are presented via one communication means and the public code via a graphics capable device.

Preferably the authentication objects are presented via one communication means and the public code via a voice capable communications means.

Preferably the user is additionally required to enter an individual password.

Preferably all data interchanged with the user is sent via a secure communications means.

In another aspect the invention relates to a server providing an authentication service to a user, the server comprising:
storage means for storing a user profile, the profile including a user name and at least one abstract definition of a user object,
serving means for serving objects when a user requests objects to allow verification of a transaction, the serving means serving multiple objects with at least one falling within the abstract definition of the user object,
comparison means for comparing a returned object definition with the user abstract definition to determine whether the transaction should be authenticated.

Preferably the server additionally detects the return of an object or code to authorize a transaction.

Preferably the server additionally detects the return of an object or code representing a duress code.

In a further aspect the invention relates to a method of providing a user interface on a computer screen allowing a user to confirm a verifiable choice of options comprising:
requiring the user to define an abstract object definition,
providing to the user multiple objects of at which at least one falls within the object definition,
requiring the user to choose one of the multiple objects,
validating the user choice against the abstract definition.

Preferably the multiple objects are graphic objects displayed on the computer screen, and the user chooses an object by focusing and clicking on the object.

### BRIEF DESCRIPTION OF THE DRAWINGS

The accompanying drawings, which are incorporated in and form a part of the specification, illustrate preferred embodiments of the present invention and, together with the description, serve to explain the principles of the invention. In the drawings:

FIG. 1 shows the system overview of a human factor authentication services.

FIG. 2 shows the role of the communications agent in authentication.

FIG. 3 illustrates the embedding of private message to carry out a human factor authentication process.

FIGS. 4 and 5, shows examples of user preferred icons as factors.

FIG. 6 shows an example of the presentation of session based authentication codes and a user command screen.

### DETAILED DESCRIPTION OF THE PREFERRED EMBODIMENTS

Reference will now be made in detail to preferred embodiments of the invention, non-limiting examples of which are illustrated in the accompanying drawings.

FIG. 1 shows the typical authentication system. The authentication server 105 contains a list of user profiles, preferences and private password and duress codes. The password and duress codes are normally chosen and entered by the user, so that they may be remembered.

The authentication server is connected to the application server 104 directly as well as through the Internet connection 106. The computer user terminal 107 is connected to the Internet 106 whilst the mobile user terminal 102 and telephone caller ID terminal 101 are connected to the telecommunication network 103. All communication between the client terminal 107 and the application server is secure, and typically uses a rolling code to ensure that the encryption alters at each query of the application server.

When a client wishes to carry out a transaction a transaction request is made to the application server 104 from terminal 107. The relevant authentication message information is retrieved from the authentication server 105 by the application server 104 and a web form is then dynamically generated by the application server. The form incorporates keys to the authentication information, but these keys must be acted upon by the user taking some action which varies in dependence on what is viewed by the user.

Each time an authentication object is activated at client terminal, a dedicated communication is made to the authentication server 105 while the client screen is refreshed with a new data object from the application server 104 and the authentication state is updated. The contents of each transaction step are varied based on the result of the previous authentication attempt which will include a new set of authentication message objects.

After the transaction steps are completed, a confirmation form will be provided together with the unique, one time only verification code embedded in a visual object or sent to the preferred communication terminal such as mobile phone 102 or caller ID terminal 101. The user then submits the transaction request by entering the verification code as received from his/her mobile terminal 102 or caller ID terminal 101 at the client terminal 102, together with the private authorization code or duress code in a request form on computer terminal 107. This may not be done in an extrinsic fashion, but may include selecting a specific visual item on the screen, the embedded code associated with that item performing the step of assembling the appropriate verification return code.

On the receipt of a verification code and user command, the following action may be carried out:
Complete the transaction if the user authorisation is confirmed;
Abort the transaction if the user authorisation is incomplete or incorrect;

Terminate the transaction or initiate an appropriate response if the user authorisation returns the duress code.

TABLE 1
Listing of human factor profile items
used in the authentication processes.

| Human Factor | | | |
|---|---|---|---|
| Objects | Sample user1 | Sample user2 | Sample user3 |
| Visual Command | Icon - Red Rose | Character - R | Custom Icon |
| objects | | | |
| Private Authori- | 1234 | Abcd | a1b2 |
| zation code | | | |
| Duress Code | 911 | 111 | 999 |
| Public Key Code | match length - | Match length - | Match length - |
| Method | front | rear | third |

These are examples of “human factor” items which are used in the variation described below. The visual command object relates to an item presented on screen to a user, the private authorisation code to a users password, the duress code is simply a code which indicates a duress situation, and the public key code method to the type of match to be made with a presented public key.

For an example of the latter, the once only public code (say “5$3h7y9lkr5” in the form of a graphic) generated by the transaction session is presented to a user and is required to be returned together with the private password (say “123456”) as being used in some two factor authentication methods. As part of the human factor authentication processes, it is a requirement for the user to view the once-only public code from a graphic and parse it into a previously defined format in real-time. With the above example, the code the user must return may be “5$3h7y123456” or “y9lkr5123456” depending on the user preference stored for that user (depending whether the stored format is “match length—rear” or “match length—front”) where the “match length” indicates that the length of the public key portion returned must match that of the user password, and the “rear” or “front” indicates that the matching portion is taken from either the front or the rear of the presented public key.

The following example describe the user actions, processes and communication activities to complete a secure transaction facilitated by human factors authentication technology, using a registered user profile as illustrated for “sample user2” above.

Step 1: Request Service

User “sample user2” logs in to the service provider's web site use the standard simple authentication method with the username and password provided to the user. This process is part of standard Internet technology. When a correct login is received the service portal page is loaded once the application server verifies that the login and password are correct.

The service portal page presents a standard menu page with a choice of items, meanwhile, as is normal practice, the web server allocates a session identity to requests from that user at that browsing machine.

Step 2: Request a Transaction

User “sample user2” requests a particular transaction type by selecting a valid menu item, for instance “Fund transfer”. Clicking or otherwise activating this choice generates a form request, normally a GET or a POST to the host web server. The application server processes the user request, validates the embedded user and session identity in the request and queries its database for information on the profile of that user.

In this case the user profile specifies that user “sample user2” has chosen human factor authentication as its online authentication agent, and a query is made to the designated human factor authentication server (105) with the unique user identification and session identifier. The human factor authentication server validates the user identifier together with the application server identifier and creates a “human factor authentication” document which is sent to the application server using the session identifier from the web server as the URL. On the receipt of the human factor authentication document URL, the application server creates a new web page from the database query and embeds data from the human factor authentication document in the served web page, replacing the command buttons which usually appear in a standard HTTP document with other items at least one of which will have some meaning only to the specific user.

Step 3: Implementing a Transaction

User “sample user2” makes a transaction choice by selecting a valid menu item or other web comparable tool such as dropdown boxes, list boxes or check boxes. If the transaction requires new user related data from the database, the user is required to click on the appropriate human factor object to proceed to next stage of transaction or the transaction will be aborted.

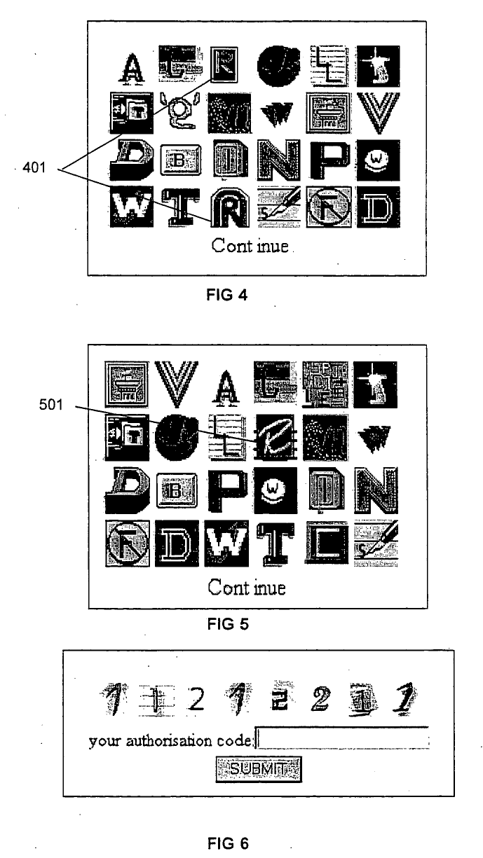

In this example, sample user2 has defined “Character-R” as his/her command object in Table 1, and the authentication server has provided a series of linked icons, as illustrated in FIG. 4. Most of the icons are randomly chosen and all are randomly placed, but two, shown at (401), are icons allocated to “Character-R”. To proceed with next stage of the transaction using human factor authentication, sample user2 will be required to click on an icon representing Character-R. Any other action will invalidate the authentication process and the transaction will be aborted. While the example shows a representation of an object meeting the users abstract definition in some instances an actual object is present, as for instance if the object is a sound clip.

FIG. 5 shows another generated response screen for the same user and it should be noted that both the icons and the placement of them differs, but that an icon meeting the requirements of Character-R is still present at (501).

If the user had been “sampleuser1” then one of the icons would have been a red rose and that icon would have been a required choice to proceed further.

Clicking an icon or a “Continue” button sends a further request to the web server identifying the chosen data and the icon which was clicked. Typically clicking any icon will send the request, but the page may be set up so that the last icon clicked prior to clicking a “Continue” button is significant.

Each time any type of data update page is presented it will be accompanied a new human factor authentication document with new set of authentication objects and layout to facilitate a new human factor authentication round.

Step 4: Transaction Submission

On receiving the transaction request from the user the application server first confirms that all data has been received in full and is valid. An authorization page is then served to the user with a randomly generated, preferably non-human readable, public code accompanied by a new human factor authentication document with a new set of authentication objects and layout. Alternatively the public code may be presented to the user via other preferred communication methods, such as SMS, using the users mobile phone number as stored in the service.

Step 5: Authorize a Transaction

FIG. 6 shows the public code presented, and the user is expected to enter the part of this that has been chosen in their profile—thus sampleuser2, whose profile shows “Match length—rear” is required to choose a length of the public code the same as the length of the users private code (4 characters) extending from the rear of the public code forwards. This user must therefore enter 1122 in the example shown. In addition the users private code must be entered, so this user would enter “Abcd1122”. The user would then click on the appropriate one of the icons also presented.

Instead of a public code accompanying the human factor authentication document as presented in the web page, a randomly generate public code may be send to user in the way of SMS message to their preferred mobile phone or to suitable text enabled communication devices.

Step 5: Raise a Duress Alarm

If “sample user2” enters his/her registered Duress code, such as “9991122” followed by clicking on the appropriate human factor object to authorize the transaction then the transaction will be aborted but an error message will be returned to the user. The error message might for instance indicate that it is not possible to carry out the transaction at the moment.

OR

Step 5: Abort a Transaction

The transaction will be aborted immediately if any object except the privately defined object required by “sample user2” is clicked or the wrong private authorization code or encoded public code is entered.

FIG. 4 shows a sample “human factor authentication” document that has a number of Human Factor Authentication object (icons) which are selected randomly and laid out in random sequence. Each Object (icon) has an active URL link or embedded data that is session generated by the authentication server but only the object (icon) relate to the registered user profile will have valid data or URL. A click on any individual object (icon) will activate a human factor authentication action of calling the authentication server, but only an object (icon) that matches the registered user profile 401 and 501 will activate a valid authentication action and allow the transaction to progress to next stage. Otherwise the transaction will be aborted.

While the example shown is of graphics presented to the user it is equally possible to provide a selection of named buttons or a series of audio clips in which only one of the names on the buttons matches the users criteria, or only one of the audio clips matches. While buttons or graphics may be presented to the user simultaneously the audio must be presented sequentially and may be chosen by selecting links for each sound and selecting “Submit” when the correct sound is heard. In this manner a secure transaction interface acceptable to persons with accessibility problems may be built.

In additional to human factor authentication objects, the “human factor authentication” document also includes a session communication agent that is pre-loaded with session related client and user data so it may not be confused with any other active session that the server may host at the same time.

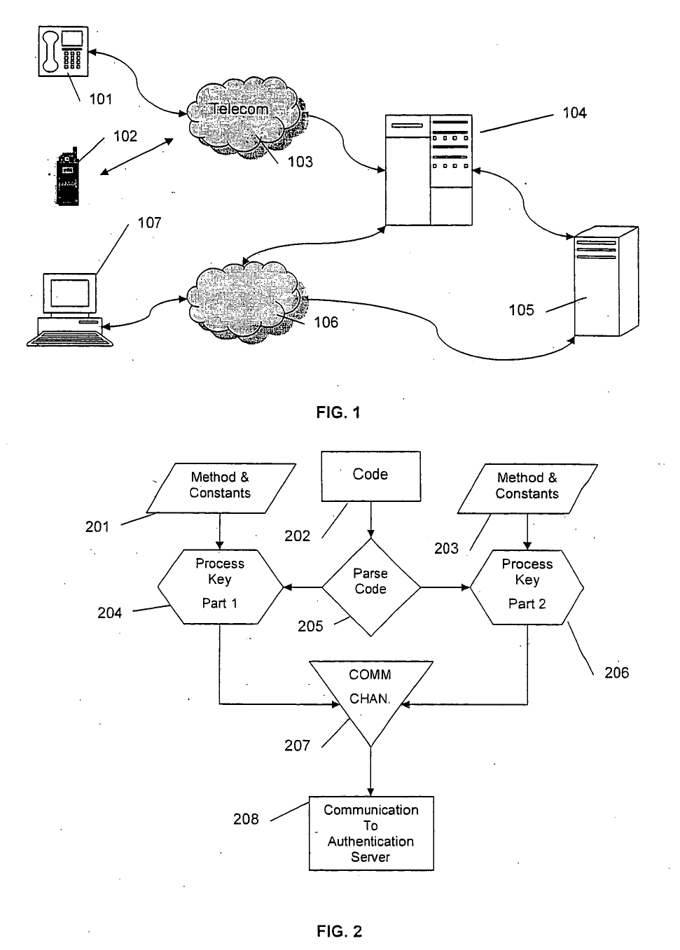

FIG. 2 illustrates how the communication agent at the client processes data associated with activities in code associated with human factor objects (icons). The communication agent encodes the data entered by the user locally and data embedded with the human factor object when it is clicked.

The method of encoding data is flexible as long the same method is applied in both the authentication server and the communication agent at the client side. In this example, the code entered by the user is split into a first and a second part at 202, each being passed to a separate process, respectively 203 and 204. In each of these processes the code is processed and returns an integer value (say 16 bit CRC). The two integer values may be returned at 207 to the web server and from this to the authentication server.

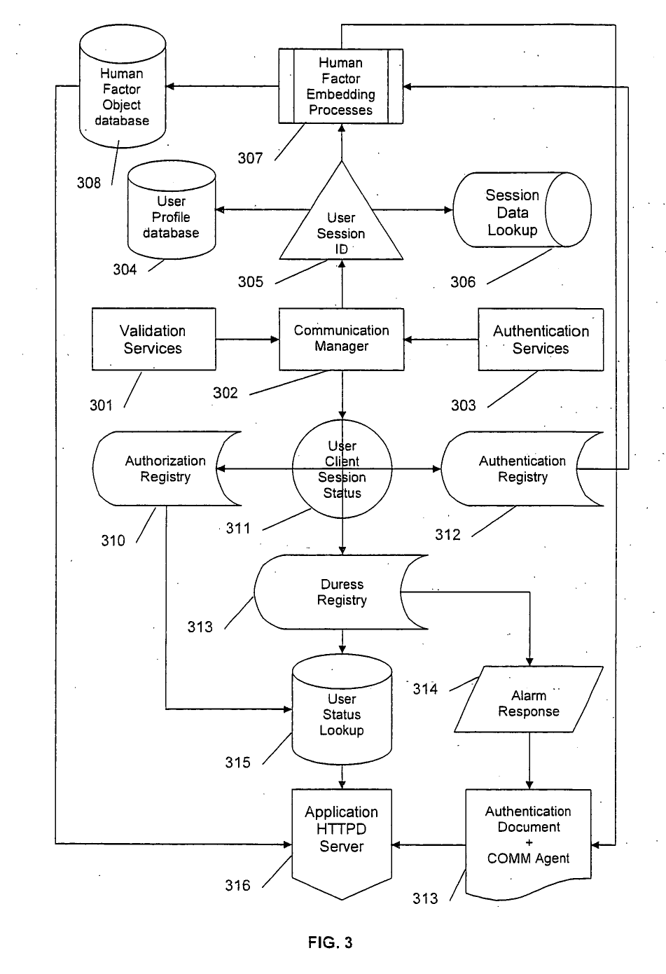

FIG. 3 shows how the processes in the transaction monitoring and alarm response system utilize human factor authentication technology. The system includes a data store 304 which retains information from an individual who is subscribed to the authentication service. Typically a user is required to register their profile by providing their personal information and biometry data sufficient to allow the system to prove their identity. The registration of this data is carried out in a private and monitored environment. To enable human factor authentication by the system, a subscriber must submit their password, duress code and personal preferences represented by visual objects as illustrated in table 1 in addition to information normally required by a service provider such as the user name and password.

In operation a request for validation is received at 301, or for authentication at 303 and the request directed to the communication manager 302. The request may be received from or at either a web server, an application server or directly from a client.

The authentication and validation services may merely be present as a dedicated link to a web server or they may be advertised as services on the internet.

When a transaction query is received by the validation service 301, the data is routed to the communication manager 302 and on to the user session processor in 305. If session data is not found stored at the session data lookup 306 then it is considered as a new request and session data for the new session is stored in session data lookup 306.

The user session processor 305 utilizes the user identifier embedded with the validation request to look up the user profile in its user profile database 304. if a matching identity is found, the user preferences is used to create a human factor authentication document at 307 where the human factor object as defined by the user profile is embedded with a valid user session key and other relevant data. This is then mixed with other non related and randomly generated human factor objects and their display layout is arranged at random as illustrated in FIGS. 4 and 5. The human factor objects stored in the human factor object database 308 are loaded for display in real-time via the application web server 316.

If authentication service 303 receives a connection request, it retrieves the session IP and session identifier and transfers the data to the communication manager 302. The communication manager routes the message to the authentication processor 311 to determine the nature of the authentication request by comparing the message with data entries located in the duress registry 313, authorization registry 310 and the authentication registry 312.

If the request is a duress alarm message, the alarm response 314 process will be activated. This may create a standard response HTTP document or simply activate a standard HTTP error code as respond. In an event of a duress alarm, further process may be activated such as notifying the appropriate authority electronically.

If it is an authorization message, and the authorization is correct, the authentication status will be updated at the user status lookup 315 and the application server can be advised that it can execute the transaction.

If it is an authentication message, the request is forwarded to the human factor embedding processes 307 to create a new human factor authentication document.

Communication with the authentication server may be carried out using the methods of New Zealand patent application 541356 in order to increase the security of the data transfer.

The foregoing description of the preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated.

What is claimed:

1. A method of authenticating a request from a user connecting to an authentication service comprising:
storing user information in the form of an abstract definition of a viewable or audible object,
receiving a request from a user to provide authentication objects for that user,
presenting authentication objects to the requester including at least one object falling within the abstract definition,
receiving a verification request identifying the user and one of the presented authentication objects,
verifying whether the authentication object identified is one of those objects presented falling within the abstract definition,
confirming the request as authenticated where the object is correctly verified.

2. A method as claimed in claim 1 wherein the authentication objects are presented to the user simultaneously.

3. A method as claimed in claim 1 wherein the authentication objects are presented to the user sequentially.

4. A method as claimed in claim 1 wherein there is additionally presented to a user an object representing a public code, and the user is required to enter specific parts of the public code, the parts being identified from further user information stored with the authentication service.

5. A method as claimed in claim 1 wherein the authentication objects are presented by one communication means and a public code by another.

6. A method as claimed in claim 1 wherein the user is additionally required to enter an individual password.

7. A method as claimed in claim 1 wherein all data interchanged with the user is sent via a secure communications means.

8. A server providing an authentication service to a user, the server comprising:
storage means for storing a user profile, the profile including a user name and at least one abstract definition of a user object,
serving means for serving objects when a user requests objects to allow verification of a transaction, the serving means serving multiple objects with at least one falling within the abstract definition of the user object,
comparison means for comparing a returned object definition with a user profile abstract definition to determine whether the transaction should be authenticated.

9. A server as claimed in claim 8 wherein the server additionally detects the return of an object or code to authorize a transaction.

10. A server as claimed in claim 8 wherein the server additionally detects the return of an object or code representing a duress code.

11. A method of providing a user interface on a computer screen allowing a user to confirm a verifiable choice of options comprising:
requiring the user to define an abstract object definition,
providing to the user multiple objects of at which at least one falls within the abstract object definition,
requiring the user to choose one of the multiple objects,
validating the user choice against the abstract object definition.

12. A method as claimed in claim 11 wherein the multiple objects are graphic objects displayed on the computer screen, and the user chooses an object by focusing and clicking on the object.
